(19) United States
(12) Patent Application Publication
(10) Pub. No.: US 2008/0143655 A1
(43) Pub. Date: Jun. 19, 2008

(54) ORGANIC LIGHT EMITTING DEVICE

(75) Inventor: Chun-Seok KO, Hwaseong-si (KR)

Correspondence Address: CANTOR COLBURN, LLP, 20 Church Street, 22nd Floor, Hartford, CT, 06103, US

(73) Assignee: SAMSUNG ELECTRONICS CO. LTD., Suwon-si (KR)

(21) Appl. No.: 11/837,112

(22) Filed: Aug. 10, 2007

(30) Foreign Application Priority Data
Dec. 15, 2006 (KR) 10-2006-0128404

(51) Int. Cl. G09G 3/32

(52) U.S. Cl. 345/82

(57) ABSTRACT

An organic light emitting device includes a display panel which includes a plurality of pixels, a power supply which generates a driving voltage, an overcurrent detector which detects an overcurrent flowing from the power supply to the display panel, and a driving voltage blocking unit which blocks the driving voltage to the plurality of pixels based on an output signal of the overcurrent detector.

This application claims priority to Korean Patent Application No. 10-2006-0128404, filed on Dec. 15, 2006, and all the benefits accruing therefrom under 35 U.S.C. §119, the contents of which in its entirety are herein incorporated by reference.

### BACKGROUND OF THE INVENTION

(a) Field of the Invention

The present invention relates to an organic light emitting device.

(b) Description of the Related Art

Recent trends towards lightweight and thin personal computers and television sets also require lightweight and thin display devices, and flat panel displays satisfying such requirements are being substituted for conventional cathode ray tubes (“CRTs”).

The flat panel displays include a liquid crystal display (“LCD”), a field emission display (“FED”), an organic light emitting device (“OLED”), a plasma display panel (“PDP”), and various other display types.

Among the flat panel displays, the OLED is the most promising because of its low power consumption, fast response time, wide viewing angle, and high contrast ratio.

An OLED is a self-emissive display device which includes two electrodes and an organic light emitting layer interposed therebetween. One of the two electrodes injects holes and the other of the two electrodes injects electrons into the light emitting layer. The injected electrons and holes are combined to form excitons, and when the excitons de-excite, they release energy in the form of visible wavelength photons.

The OLED includes a plurality of pixels, each including a switching transistor, a driving transistor, and a light emission layer. The switching transistor is connected to a signal line and controls the application of a data voltage to the driving transistor, the driving transistor includes a gate terminal which is supplied with the data voltage from the switching transistor as a gate voltage and drives a current having a magnitude determined depending on the magnitude of the data voltage, and the current from the driving transistor enters the light emission layer to cause light emission having intensity depending on the current from the driving transistor. The driving transistor receives a driving voltage as an input voltage and the current output from the driving transistor is based on the gate voltage.

However, when a wire which transmits the driving voltage is shorted to another voltage wire or a common electrode, or various other electrical conduits within or outside the display device, an overcurrent flows such that damage to the driving devices of the OLED or potentially dangerous generation of heat occurs.

### BRIEF SUMMARY OF THE INVENTION

According to an exemplary embodiment of the present invention, an organic light emitting device includes; a display panel which includes a plurality of pixels, a power supply which generates a driving voltage, an overcurrent detector which detects an overcurrent flowing from the power supply to the display panel, and a driving voltage blocking unit which blocks the driving voltage to the plurality of pixels based on an output signal of the overcurrent detector.

In one exemplary embodiment of the overcurrent detector includes; first and second resistors connected in parallel, a first switching element which includes a first control terminal, a first input terminal, and a first output terminal, wherein the first control terminal is connected to the first and second resistors, and a detector output terminal connected to the first output terminal.

In one exemplary embodiment the organic light emitting device may further include a third resistor connected to the first input terminal, and a fourth resistor connected to the first output terminal.

In one exemplary embodiment the organic light emitting device may further include a first diode connected to the first control terminal, and a second diode connected to the first output terminal.

In one exemplary embodiment the first switching element may be turned on when the overcurrent flows from the power supply to the display panel, and the first switching element may be turned off when the overcurrent does not flow from the power supply to the display panel.

In one exemplary embodiment an overcurrent detection signal having a high voltage level may be output when the first switching element is turned on, and an overcurrent detection signal having a low voltage level may be output when the first switching element is turned off.

In one exemplary embodiment the driving voltage blocking unit may include a second switching element which includes a second control terminal, a second input terminal, and a second output terminal, a blocking unit input terminal connected to the second control terminal, and a relay which includes a coil connected to the second input terminal and a switch connected to the power supply and the display panel.

In one exemplary embodiment the organic light emitting device may further include a fifth resistor connected to the second input terminal, and a sixth resistor connected to the second control terminal.

In one exemplary embodiment the second switching element may be turned off when the overcurrent does not flow from the power supply to the display panel, and the second switching element may be turned on when the overcurrent flows from the power supply to the display panel.

In one exemplary embodiment the switch may be closed when the second switching element is turned off, and the switch may be opened when the second switching element is turned on.

In one exemplary embodiment the detector output terminal and the blocking unit input terminal may be connected.

In one exemplary embodiment the organic light emitting device may further include a signal controller which controls signals applied to the plurality of pixels, wherein an output signal from the detector output terminal may be applied to the signal controller, and the signal controller supplies an input signal to the blocking unit input terminal.

In one exemplary embodiment the organic light emitting device may further include; a data driver attached on the display panel which transmits data voltages to the plurality of pixels, and a printed circuit board attached to the data driver.

In one exemplary embodiment the organic light emitting device may further include a flexible printed circuit film attached on the display panel which transmits the driving voltage to the pixels.

In one exemplary embodiment the overcurrent blocking unit and the driving voltage blocking unit may be disposed on the printed circuit board.

In another exemplary embodiment of the present invention a method of driving an organic light emitting device includes; generating a driving voltage to drive a plurality of pixels of a display panel, providing the driving voltage to an overcurrent detector, detecting the presence of an overcurrent in the overcurrent detector, generating an output signal from the overcurrent detector, generating an output signal from the overcurrent detector which corresponds to the detection of an overcurrent, and blocking the driving voltage to the plurality of pixels of the display panel based on the output signal from the overcurrent detector using a driving voltage blocking unit.

### BRIEF DESCRIPTION OF THE DRAWINGS

The present invention will become more apparent by describing exemplary embodiments thereof in further detail with reference to the accompanying drawings, in which:

FIG. 1 is a block diagram of an exemplary embodiment of an organic light emitting device (“OLED”) according to the present invention;

FIG. 2 is an equivalent circuit diagram of an exemplary embodiment of a pixel of an OLED according to the present invention;

FIG. 3 is a cross-sectional diagram of an exemplary embodiment of a driving transistor and an organic light emitting diode of a pixel of an OLED according to the present invention;

FIG. 4 is a schematic diagram of an exemplary embodiment of an organic light emitting diode according to the present invention;

FIG. 5 is a schematic top plan view layout of an exemplary embodiment of an OLED device according to the present invention;

FIG. 6 is a block diagram representing a connection relationship between a driving voltage adjuster, a signal controller, and a display panel of an exemplary embodiment of an OLED device according to the present invention;

FIG. 7 is a circuit schematic diagram of an exemplary embodiment of an overcurrent detector of an exemplary embodiment of an OLED device according to the present invention; and

FIG. 8 is a circuit schematic diagram of an exemplary embodiment of a driving voltage blocking unit of an exemplary embodiment of an OLED device according to the present invention.

### DETAILED DESCRIPTION OF THE INVENTION

The present invention will now be described more fully hereinafter with reference to the accompanying drawings, in which exemplary embodiments of the present invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present invention.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the figures. For example, if the device in one of the figures is turned over, elements described as being on the “lower” side of other elements would then be oriented on the “upper” side of the other elements. The exemplary term “lower” can therefore encompass both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can therefore encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross-sectional illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

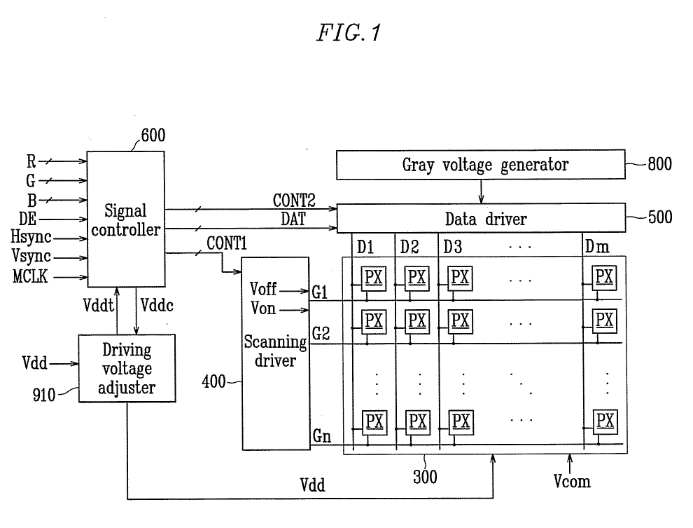

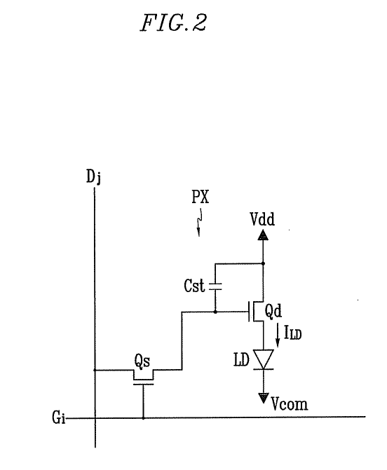

FIG. 1 is a block diagram of an exemplary embodiment of an organic light emitting diode device (“OLED”) according to the present invention, and FIG. 2 is an equivalent circuit diagram of an exemplary embodiment of a pixel of an OLED according to the present invention.

Referring to FIG. 1, an exemplary embodiment of an OLED includes a display panel 300, a scanning driver 400 and a data driver 500 which are connected to the display panel 300, a gray voltage generator 800 connected to the data driver 500, a driving voltage adjuster 910, and a signal controller 600 which controls the above elements.

The display panel 300 includes a plurality of signal lines G₁-Gₙ and D₁-Dₘ, a plurality of voltage lines (not shown), and a plurality of pixels PX connected to the signal lines G₁-Gₙ and D₁-Dₘ and the voltage lines and arranged substantially in a matrix, as shown in the equivalent circuit diagram of FIG. 2.

The signal lines G₁-Gₙ and D₁-Dₘ include a plurality of scanning lines G₁-Gₙ for transmitting scanning signals, a plurality of data lines D₁-Dₘ for transmitting data signals, and a plurality of driving voltage lines (not shown) for transmitting a driving voltage Vdd. The scanning lines G₁-Gₙ extend substantially in a row direction and are substantially parallel to each other, while the data lines D₁-Dₘ and the driving voltage lines extend substantially in a column direction and are substantially parallel to each other. The scanning lines G₁-Gₙ are substantially perpendicular to the data lines D₁-Dₘ and the driving voltage lines.

The driving voltage lines extend substantially parallel to the data lines D₁-Dₘ and are positioned on an upper or lower portion of the display panel 300 to be supplied with the driving voltage Vdd. However, alternative exemplary embodiments include configurations wherein the driving voltage lines may be parallel to the scanning lines G₁-Gₙ.

As shown in FIG. 2, each pixel PX, such as a pixel PX which is connected to a scanning line Gᵢ and a data line Dⱼ, includes an organic light emitting diode LD, a driving transistor Qd, a storage capacitor Cst, and a switching transistor Qs.

In one exemplary embodiment the switching transistor Qs may be a three-terminal element and as such includes a control terminal connected to the scanning line Gᵢ, an input terminal connected to the data line Dⱼ, and an output terminal connected to the capacitor Cst and the driving transistor Qd. The switching transistor Qs transmits a data voltage from the data line Dj in response to a scanning signal from the scanning line Gi.

In one exemplary embodiment the driving transistor Qd may be a three-terminal element and as such includes a control terminal connected to the switching transistor Qs, an input terminal connected to a driving voltage line (not shown) transmitting a driving voltage Vdd, and an output terminal connected to the organic light emitting diode LD. The driving transistor Qd transmits a driving current I_{LD} which is varied according to a voltage difference between the control terminal and the output terminal thereof.

The storage capacitor Cst is connected between the control terminal of the driving transistor Qd and the terminal of the driving voltage Vdd. The storage capacitor Cst charges a data voltage which is applied to the control terminal of the driving transistor Qd and maintains the data voltage for a predetermined time after the switching transistor Qs is turned off.

The organic light emitting diode LD may include an anode and a cathode which are connected to the output terminal of the driving transistor Qd and the common voltage Vcom, respectively

The organic light emitting diode LD emits light with an intensity according to a current I_{LD} supplied by the driving transistor Qd. An OLED then uses a plurality of the pixels in conjunction to display images. In order to display moving images the OLED uses the plurality of pixels to rapidly display a series of images. Each image in the series is referred to as a frame. A human observer perceives the rapidly displayed series of images as motion.

In one exemplary embodiment, each of the switching transistor Qs and the driving transistor Qd may be composed of an n-channel field effect transistor (“FET”) which contains amorphous silicon (“a-Si”) or polysilicon. Alternative exemplary embodiments include configurations wherein at least one of the switching transistor Qs and the driving transistor Qd may be composed of a p-channel field effect transistor. In addition, alternative exemplary embodiments include configurations wherein a connection relationship of the transistors Qs and Qd, the storage capacitor Cst, and the organic light emitting diode LD may be changed.

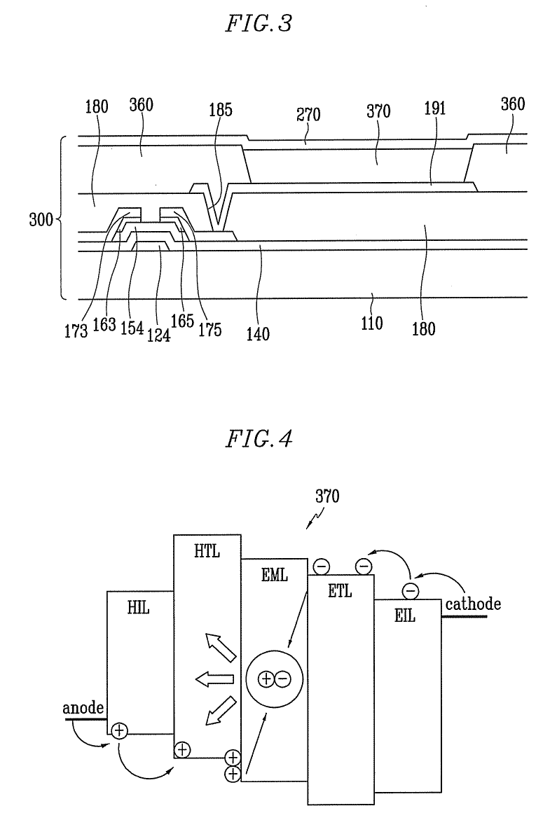

Hereinafter, a structure of the driving transistor Qd and the organic light emitting diode LD of the OLED shown in FIG. 2 will be described in detail with reference to FIGS. 3 and 4, respectively.

FIG. 3 is a cross-sectional diagram of an exemplary embodiment of a driving transistor and an organic light emitting diode of the one pixel of the OLED shown in FIG. 2, and FIG. 4 is a schematic diagram of an exemplary embodiment of an organic light emitting diode of an OLED device according to the present invention.

A control electrode 124 is formed on an insulating substrate 110. In one exemplary embodiment the control electrode 124 is made of Al or an Al alloy, Ag or an Ag alloy, Cu or a Cu alloy, Mo or a Mo alloy, Cr, Ti, Ta, or any combination thereof. Exemplary embodiments of the control electrode 124 may have a multi-layered structure including two films having different physical characteristics. One of the two films may be made of a low resistivity metal, exemplary embodiments of which include Al, an Al alloy, Ag, a Ag alloy, Cu, a Cu alloy, or any combination thereof for reducing signal delay or voltage drop. The other film may be made of a material, exemplary embodiments of which include Mo, a Mo alloy, Cr, Ta, Ti, or any combination thereof, which has good physical, chemical, and electrical contact characteristics with other materials such as indium tin oxide (“ITO”) or indium zinc oxide (“IZO”). Exemplary embodiments of the combination of the two films are a lower Cr film and an upper Al alloy film and a lower Al alloy film and an upper Mo alloy film. However, alternative exemplary embodiments include configurations wherein the control electrode 124 may be made of various other metals or conductors.

The lateral sides of the control electrode 124 are inclined relative to a surface of the substrate, and in one exemplary embodiment the inclination angle thereof ranges from about 30 degrees to about 80 degrees.

An insulating layer 140, exemplary embodiments of which are made of silicon nitride (“SiNx”), is formed on the control electrode 124.

A semiconductor 154, exemplary embodiments of which are made of hydrogenated a-Si or polysilicon, is formed on the insulating layer 140.

A pair of ohmic contacts 163 and 165, exemplary embodiments of which may be made of silicide or n+hydrogenated a-Si heavily doped with an n-type impurity such as phosphorous, are formed on the semiconductor 154.

The lateral sides of the semiconductor 154 and the ohmic contacts 163 and 165 are inclined relative to the surface of the substrate 110, and in one exemplary embodiment the inclination angles thereof range from about 30 degrees to about 80 degrees.

An input electrode 173 and an output electrode 175 are formed on the ohmic contacts 163 and 165 and the insulating layer 140. Exemplary embodiments of the input electrode 173 and the output electrode 175 may be made of a refractory metal such as Cr, Mo, Ti, Ta, or alloys thereof. Exemplary embodiments of the input electrode 173 and the output electrode 175 may have a multi-layered structure including a lower refractory metal film (not shown) and an upper low resistivity film (not shown). One exemplary embodiment of the multi-layered structure is a double-layered structure including a lower Cr/Mo alloy film and an upper Al alloy film. Another exemplary embodiment of the multi-layered structure is a triple-layered structure including a lower Mo alloy film, an intermediate Al alloy film, and an upper Mo alloy film. The input electrode 173 and the output electrode 175 have inclined edge profiles, and in one exemplary embodiment the inclination angles thereof range from about 30 degrees to about 80 degrees, similar to the control electrode 124.

The input electrode 173 and the output electrode 175 are separated from each other and disposed opposite each other with respect to the control electrode 124. The control electrode 124, the input electrode 173, and the output electrode 175 along with the semiconductor 154 form a driving transistor Qd having a channel located between the input electrode 173 and the output electrode 175.

The ohmic contacts 163 and 165 are interposed between the underlying semiconductor 154 and the overlying electrodes 173 and 175, and reduce the contact resistance therebetween. The semiconductor 154 includes an exposed portion, which is not covered by the ohmic contacts 163 and 165 or the input electrode 173 and the output electrode 175.

A passivation layer 180 is formed on the input electrode 173 and the output electrode 175, the exposed portion of the semiconductor 154, and the insulating layer 140. Exemplary embodiments of the passivation layer 180 are made of an inorganic insulator such as SiNₓ or SiO₂, an organic insulator, or a low dielectric insulator. In one exemplary embodiment the low dielectric insulator may have a dielectric constant of less than about 4.0, and examples of the low dielectric insulator may be a-Si:C:O, a-Si:O:F, or various other similar materials, made by plasma enhanced chemical vapor deposition (“PECVD”) or other similar methods.

In the exemplary embodiment where the passivation layer 180 is an organic insulator, it may have photosensitivity and a substantially flat top surface.

Alternative exemplary embodiments include configurations where the passivation layer 180 may include a lower film of an inorganic insulator and an upper film of an organic insulator such that it possesses the excellent insulating characteristics of the organic insulator while preventing the exposed portions of the semiconductor 154 from being damaged by the organic insulator. The passivation layer 180 has a contact hole 185 exposing the output electrode 175.

A pixel electrode 191 is formed on the passivation layer 180. The pixel electrode 191 is physically and electrically connected to the output terminal electrode 175 through the contact hole 185. Exemplary embodiments of the pixel electrode 191 may be made of a transparent conductor such as ITO or IZO, or a reflective metal such as Ag, Al, or alloys thereof.

A partition 360 is formed on the passivation layer 180 and portions of the pixel electrode 191. The partition 360 encloses the pixel electrode 191 to define an opening on the pixel electrode 191. Exemplary embodiments of the partition 360 are made of an organic or inorganic insulating material.

An organic light emitting member 370 is formed on the pixel electrode 191 and is confined in the opening enclosed by the partition 360.

Referring to FIG. 4, exemplary embodiments of the organic light emitting member 370 have a multi-layered structure including an emitting layer EML and auxiliary layers for improving the efficiency of light emission of the emitting layer EML. The auxiliary layers may include an electron transport layer ETL and a hole transport layer HTL for improving the balance of electrons and holes delivered to the emitting layer EML, and an electron injecting layer EIL and a hole injecting layer HIL for improving the injection of the electrons and holes into the electron transporting layer ETL and hole transporting layer HTL, respectively. Alternative exemplary embodiments include configurations wherein one or more of the auxiliary layers may be omitted.

Further, the emission layer EML of each pixel emits one primary color light depending on a material of the light emitting member 370. In one exemplary embodiment the primary colors may be red, green, and blue.

Alternative exemplary embodiments include configurations wherein the emission layer EML may include a plurality of sub-emission layers (not shown) sequentially deposited with materials which emit light of one of a plurality of colors such as red, green, and blue, and may emit white light by a combination of the colors. In such an alternative exemplary embodiment each pixel may include color filters (not shown), exemplary embodiments of which are red, green, and blue.

A common electrode 270 applied with a common voltage (Vcom) is formed on the partition 360 and the organic light emitting member 370.

The common electrode 270 is formed of a reflective metal. In exemplary embodiments, the reflective metal contains a material such as Ca, Ba, Al, Ag, or other similar materials, or a transparent conductive material such as ITO or IZO.

A combination of opaque pixel electrodes 191 and a transparent common electrode 270 is employed in a top-emission type of OLED which emits light toward the top of the display panel 300, and a combination of transparent pixel electrodes 191 and an opaque common electrode 270 is employed in a bottom-emission type of OLED which emits light toward the bottom of the display panel 300.

As shown in FIGS. 2 and 3, a pixel electrode 191, an organic light emitting member 370, and a common electrode 270 form an organic light emitting diode LD having the pixel electrode 191 as an anode and the common electrode 270 as a cathode, or vice versa.

According to the present exemplary embodiment, the organic light emitting diode LD of each pixel emits light of one primary color depending on the material used to construct the light emitting member 380. One exemplary embodiment of a set of primary colors may include red, green, and blue, or may further include white as well as the three primary colors, and a spatial sum of the three primary colors, or the three primary colors and a white color, may represent a desired color.

Referring to FIG. 1 again, the gray voltage generator 800 generates a plurality of reference gray voltages related to the transmittanceof the pixels PX.

In the present exemplary embodiment the number of the reference gray voltages is less than the total number of gray voltages.

The scanning driver 400 is connected to the scanning lines G₁-Gₙ of the display panel 300 and synthesizes a high voltage Von for turning-on the switching transistors Qs and a low voltage Voff for turning-off the switching transistors Qs in order to generate the scanning signals for application to the scanning lines G₁-Gₙ.

The data driver 500 is connected to the data lines D₁-Dₘ, and divides the reference gray voltages supplied from the gray voltage generator 800 to generate data voltages and apply them to the data lines D₁-Dₘ.

The driving voltage adjuster 910 determines whether an overcurrent is supplied based on the driving voltage Vdd applied from an external power supply and blocks the driving voltage Vdd when such an overcurrent is present.

The signal controller 600 controls the scanning driver 400, the data driver 500, the gray voltage generator 800, and various other parts of the OLED.

In one exemplary embodiment the driving devices 400, 500, 600, and 800 may be integrated into the substrate 110 along with the signal lines G₁-Gₙ and D₁-Dₘ and the switching elements Q. Each of driving devices 400, 500, 600, and 800 may include at least one integrated circuit (“IC”) chip mounted on the substrate 110 or on a flexible printed circuit (“FPC”) film in a tape carrier package (“TCP”), which is attached to the substrate 110. Alternative exemplary embodiments include configurations wherein all the driving devices 400, 500, 600, and 800 may be integrated into a single IC chip, and other alternative exemplary embodiments include configurations wherein one or more of the driving devices 400, 500, 600, and 800 or one or more circuit elements in at least one of the driving devices 400, 500, 600, and 800 may be disposed outside of the single IC chip.

Now, the operation of the above-described OLED will be described in detail.

The signal controller 600 is supplied with input image signals R, G, and B and input control signals for controlling the display thereof from an external graphics controller (not shown). The input image signals R, G, and B contain luminance information for pixels PX, and the luminance has a predetermined number of grays, for example 1024 (=2¹⁰), 256 (=2⁸), or 64 (=2⁶) grays. The input control signals include a vertical synchronization signal Vsync, a horizontal synchronization signal Hsync, a main clock signal MCLK, and a data enable signal DE.

The signal controller 600 generates scanning control signals CONT1, data control signals CONT2, and gray voltage control signals CONT3 based on the input control signals and the input image signals R, G, and B, and it processes the image signals R, G, and B to be suitable for the operation of the display panel 300 and the data driver 500. The signal controller 600 sends the scanning control signals CONT1 to the scanning driver 400 and sends the processed image signals DAT and the data control signals CONT2 to the data driver 500.

The scanning control signals CONT1 include a scanning start signal STV for instructing the scanning driver 400 to start scanning and at least one clock signal for controlling the output period of the gate-on voltage Von. The scanning control signals CONT1 may include an output enable signal OE for defining the duration of the gate-on voltage Von.

The data control signals CONT2 include a horizontal synchronization start signal STH for informing the data driver 500 of the start of data transmission for a row of pixels PX, a load signal LOAD for instructing the data driver 500 to apply the data voltages to the data lines D₁-Dₘ, and a data clock signal HCLK. The data control signal CONT2 may further include an inversion signal RVS for reversing the polarity of the data voltages (relative to the common voltage Vcom), such an inversion signal is typically used in liquid crystal displays (“LCDs”).

The gray voltage generator 800 generates the reference gray voltages to apply to the data driver 500.

The data driver 500 divides the reference gray voltage to generate even more gray voltages which are used to display all of the grays used in the display. Responsive to the data control signals CONT2 from the signal controller 600, the data driver 500 also receives a packet of the digital image signals DAT for the row of pixels PX from the signal controller 600, converts the digital image signals DAT into analog data voltages selected from the at least one of the plurality of divided gray voltages, and applies the analog data voltages to the data lines D₁-Dₘ.

The scanning driver 400 applies the high voltage Von to a scanning line G₁-Gₙ in response to the gate control signals CONT1 from the signal controller 600, thereby turning on the switching transistors Qs connected to the scanning line G₁-Gₙ. The data voltages applied to the data lines D₁-Dₘ are then supplied to the control terminal of the driving transistors Qd of the pixels PX through the activated switching transistors Qs.

The data voltage applied to the driving transistor Qd is then charged in a capacitor Cst. Once charged, even though the switching transistor Qs is turned off, the charged data voltage is maintained. The driving transistor Qd is turned on by the applied data voltage, and outputs a current I_{LD} with a magnitude dependent on the data voltage. In addition, the organic light emitting diode LD emits light of an intensity which varies based on the driving current I_{LD}, and thereby the corresponding pixel PX displays an image.

After one horizontal period (or “1H”) (one period of a horizontal synchronization signal (Hsync) and a data enable signal (DE)), the data driver 500 and the scanning driver 400 repeat the same operation for pixels PX of the next row. In this way, a scanning signal is sequentially applied to all scanning lines G₁ to Gₙ and a data voltage is applied to all pixels PX in order to display one frame. When one frame is completed, the next frame starts, and the same operations are repeated during a subsequent frame, and thereby moving images may be displayed.

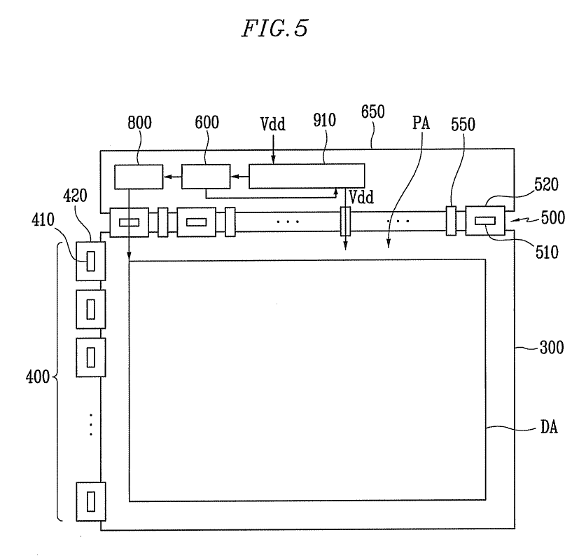

Next, referring to FIG. 5, a schematic top plan view layout of an exemplary embodiment of an OLED according to the present invention will be described in detail.

Referring to FIG. 5, an exemplary embodiment of an OLED includes a display panel 300. The display panel 300 is divided into a display area DA displaying images and a peripheral area PA surrounding the display area DA.

On the display area DA, the scanning lines (not shown), the data lines (not shown) intersecting the scanning lines, the transistors (not shown) connected to the scanning lines and the data lines, and the pixel electrodes (not shown) connected to the transistors, and the various other previously described elements of an OLED, are formed.

The scanning driver 400 is attached on a portion of the peripheral area PA, that is, on one side portion with respect to the display area DA. The scanning driver 400 is formed as a TCP wherein a chip 410 is mounted on a base film 420. However, alternative exemplary embodiments include configurations wherein the scanning driver 400 may be formed along with the scanning lines, the data lines, and the transistors on the display panel 300.

On one portion of the peripheral area PA, in the current exemplary embodiment the upper portion with respect to the display area DA, the data driver 500 and the FPC films 550 are attached. The data driver 500 is attached on the display panel 300 in a TCP type, which includes a plurality of IC chips 510 mounted on the base film 520, and the FPC film 550 transmits the driving voltage Vdd or the common voltage Vcom to the display area DA. However, alternative exemplary embodiments include configurations wherein the data driver 500 may include a dummy line, to transmit the driving voltage Vdd or the common voltage Vcom through the dummy line.

The PCB 650 is attached on the base film 520 of the data driver 500 and the FPC film 550. The signal controller 600, the gray voltage generator 800, and the driving voltage adjuster 910, and various other components of the OLED, are formed on the PCB 650.

Alternative exemplary embodiments include configurations wherein, a driving chip (not shown), which includes the data driver 500, the signal controller 600, and the gray voltage generator 800 may be attached on the display panel 300.

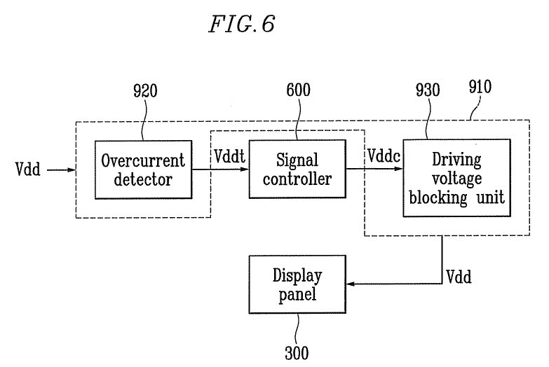

Hereinafter, referring to FIGS. 6 to 8, the driving voltage adjuster 910 of the exemplary embodiment of an OLED will be described in detail.

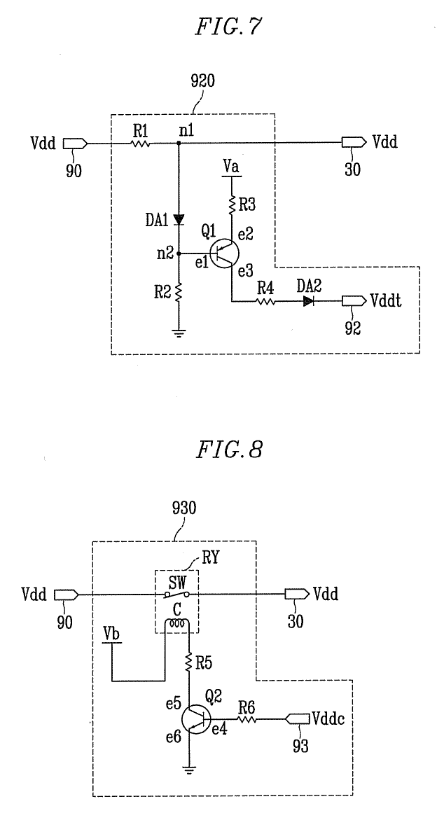

FIG. 6 is a block diagram representing a connection relationship between a driving voltage adjuster, a signal controller, and a display panel of an exemplary embodiment of an OLED according to the present invention, FIG. 7 is a circuit diagram of an exemplary embodiment of an overcurrent detector of an exemplary OLED according to an exemplary embodiment of the present invention, and FIG. 8 is a circuit diagram of an exemplary embodiment of a driving voltage blocking unit of an OLED according to the present invention.

Referring to FIG. 6, the driving voltage adjuster 910 of the exemplary embodiment of an OLED includes an overcurrent detector 920 and a driving voltage blocking unit 930.

The overcurrent detector 920 detects whether an overcurrent flows through a wire (not shown) transmitting the driving voltage Vdd from the external power supply device to the pixels PX. An overcurrent is an excess of current over that which is desired to be supplied to the pixels PX. Overcurrents may be generated by a plurality of sources including normal variations in driving voltage Vdd output generated by the power supply device, static discharges, short circuits, and various other mechanisms.

The overcurrent detector 920 generates an overcurrent detection signal Vddt and applies it to the signal controller 600. The overcurrent detector 920 generates an overcurrent detection signal Vddt of varying voltage levels depending on whether an overcurrent flows through the wire which transmits the driving voltage Vdd, which will be discussed in more detail below.

Upon receiving the overcurrent detection signal Vddt the signal controller 600 generates a driving voltage control signal Vddc based on the overcurrent detection signal Vddt to transmit to the driving voltage blocking unit 930.

The driving voltage blocking unit 930 is supplied with the driving voltage control signal Vddc from the signal controller 600 and blocks the driving voltage Vdd flowing though the wiring.

Referring to FIG. 7, the overcurrent detector 920 is connected between an output terminal 90 of the power supply, which generates the driving voltage Vdd, and an input terminal 30 of the display panel 300, and includes a detector output terminal 92.

The detector output terminal 92 outputs the overcurrent detection signal Vddt, and the overcurrent detection signal Vddt has a high level H or a low level L based on the detection of the overcurrent. In the current exemplary embodiment, when the overcurrent is detected, the overcurrent detection signal Vddt may be the high level H, and when the overcurrent is not detected, the overcurrent detection signal Vddt may be the low level L. However, alternative exemplary embodiments include configurations wherein the level of the overcurrent detection signal Vddt based on the detection of the overcurrent may be varied.

The over current detector 920 includes resistors R1-R4, diodes DA1 and DA2, and a transistor Q1.

The resistor R1 is connected between the output terminal 90 of the power supply and the input terminal 30 of the display panel 300, and an anode terminal of the diode DA1 is connected to the input terminal 30 of the display panel 300 and the first resistor R1.

The resistor R2 is connected between a cathode terminal of the diode DA1 and a ground terminal, and the resistor R3 is connected to a voltage Va.

The transistor Q1 includes a control terminal e1, an input terminal e2, and an output terminal e3.

The control terminal e1 of the transistor Q1 is connected to a node n2 disposed between the diode DA1 and the resistor R2, the input terminal e2 of the transistor Q1 is connected to the resistor R3, and the output terminal e3 of the transistor Q1 is connected to a terminal of the resistor R4.

The remaining terminal of the resistor R4 is connected to an anode terminal of the diode DA2, and a cathode terminal of the diode DA2 is connected to the detector output terminal 92.

In one exemplary embodiment the first transistor Q1 may be a PNP type, and resistance ratio of the resistors R1 and R2 may be about 1:1.

The resistors R3 and R4 and the diodes DA1 and DA2 protect the first transistor Q1, and may be omitted in alternative exemplary embodiments.

Next, referring to FIG. 8, the driving voltage blocking unit 930 includes a transistor Q2, resistors R5 and R6, and a relay RY. The driving voltage blocking unit 930 also includes a blocking unit input terminal 93.

The relay RY includes a switch SW connected between the output terminal 90 of the power supply and the input terminal 30 of the display panel 30, and a coil C connected to a voltage Vb and the resistor R5. The coil C is disposed substantially opposite to the switch SW.

The transistor Q2 includes a control terminal e4, an input terminal e5, and an output terminal e6. The control terminal e4 of the transistor Q2 is connected to the resistor R6, which in turn is connected to the blocking unit input terminal 93, the input terminal e5 of the transistor Q2 is connected to the resistor R5, and the output terminal e6 of the transistor Q2 is grounded.

In one exemplary embodiment the second transistor Q2 may be a NPN type.

The resistors R5 and R6 protect the transistor, and alternative exemplary embodiments include configurations wherein the resistors R5 and R6 may be omitted.

Now, an operation of the driving voltage adjuster will be described with reference to FIGS. 7 and 8.

When an overcurrent does not flow between the output terminal 90 of the power supply and the display panel 300, the control terminal e1 of the first transistor Q1 has a high voltage level H, and thereby the transistor Q1 is turned off. The resistors R1 and R2 function to filter unwanted fluctuations from the voltage supplied to the control terminal e1. Thus, a voltage level of an overcurrent detection signal Vddt is at a low level L1.

However, when an overcurrent flows between the output terminal 90 of the power supply and the display panel 300, current flowing in the resistor R1 increases, and thereby a voltage of the node n2 decreases. Thus, the control terminal e1 is transitioned to a low voltage level L, and thereby the transistor Q1 is turned on. Thus, the voltage Va of a high voltage level H is output through the detector output terminal 92. Therefore, the voltage level of the overcurrent detection signal Vddt is at a high voltage level H.

The overcurrent detection signal Vddt of the detector output terminal 92 is applied to the signal controller 600. The signal controller 600 applies an overcurrent control signal Vddc of an appropriate voltage level to the blocking unit input terminal 93 based on the voltage level of the overcurrent detection signal Vddt. In the current exemplary embodiment, when the overcurrent detection signal Vddt has a high voltage level H, the signal controller 600 outputs the overcurrent control signal Vddc ofa high voltage level H as well, and when the overcurrent detection signal Vddt has a low voltage level L, the signal controller 600 outputs the overcurrent control signal Vddc of a low voltage level L as well. However, the relationship of the voltage levels of the overcurrent detection signal Vddt and the overcurrent control signal Vddc may be changed, e.g., the outputs may be reversed. In addition, the high voltage levels output by the overcurrent detector 920 and the signal controller 600 may have different voltage levels, e.g., the overcurrent detection signal Vddt may have a high voltage level of about 5 volts and the high voltage level of the overcurrent control signal Vddc may be about 10 volts; similarly the low voltage levels output by the overcurrent detector 920 and the signal controller 600 may also be different.

When the overcurrent control signal Vddc having the low level L is applied to the control terminal e4 of the transistor Q2 through the resistor R6, the transistor Q2 is turned off. Thus, since current does not flow though the coil C of the relay RY, the switch SW of the relay RY is closed to maintain an initial state, and thereby the driving voltage Vdd is normally applied from the output terminal 90 of the power supply to the input terminal 30 of the display panel 300.

However, when the overcurrent control signal Vddc has the high level H, the transistor Q2 is turned on. Thus, a current corresponding to the difference between the voltage Vb and the ground state flows through the coil C and the turned-on transistor Q2, and thereby the relay RY operates such that the switch SW is disconnected. Therefore, the driving voltage Vdd from the output terminal 90 of the power supply is not applied to the input terminal 30 of the display panel 300.

In an alternative exemplary embodiment the overcurrent detection signal Vddt may be directly applied to the blocking unit input terminal 93 instead of the application to the signal controller 600, and the overcurrent detection signal Vddt and the overcurrent control signal Vddc may be substantially the same signal.

According to the present invention, when a wiring transmitting a driving voltage and a common electrode, or various other electrical conduits within or outside the display device, is shorted, an overcurrent of the wiring is detected and blocked. Thereby, damage of the driving devices of an OLED and generation of heat are prevented.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An organic light emitting device comprising:
a display panel which includes a plurality of pixels;
a power supply which generates a driving voltage;
an overcurrent detector which detects an overcurrent flowing from the power supply to the display panel; and
a driving voltage blocking unit which blocks the driving voltage to the plurality of pixels based on an output signal of the overcurrent detector.

2. The organic light emitting device of claim 1, wherein the overcurrent detector comprises:
first and second resistors connected in parallel;
a first switching element which includes a first control terminal, a first input terminal, and a first output terminal, wherein the first control terminal is connected to the first and second resistors; and
a detector output terminal connected to the first output terminal.

3. The organic light emitting device of claim 2, further comprising a third resistor connected to the first input terminal, and a fourth resistor connected to the first output terminal.

4. The organic light emitting device of claim 2, further comprising a first diode connected to the first control terminal, and a second diode connected to the first output terminal.

5. The organic light emitting device of claim 2, wherein the first switching element is turned on when the overcurrent flows from the power supply to the display panel, and the first switching element is turned off when the overcurrent does not flow from the power supply to the display panel.

6. The organic light emitting device of claim 5, wherein an overcurrent detection signal having a high voltage level is output when the first switching element is turned on, and an overcurrent detection signal having a low voltage level is output when the first switching element is turned off.

7. The organic light emitting device of claim 2, wherein the driving voltage blocking unit comprises:
a second switching element which comprises a second control terminal, a second input terminal, and a second output terminal;
a blocking unit input terminal connected to the second control terminal; and
a relay which comprises a coil connected to the second input terminal and a switch connected to the power supply and the display panel.

8. The organic light emitting device of claim 7, further comprising a fifth resistor connected to the second input terminal, and a sixth resistor connected to the second control terminal.

9. The organic light emitting device of claim 7, wherein the second switching element is turned off when the overcurrent does not flow from the power supply to the display panel, and the second switching element is turned on when the overcurrent flows from the power supply to the display panel.

10. The organic light emitting device of claim 9, wherein the switch is closed when the second switching element is turned off, and the switch is opened when the second switching element is turned on.

11. The organic light emitting device of claim 7, wherein the detector output terminal and the blocking unit input terminal are connected.

12. The organic light emitting device of claim 7, further comprising a signal controller which controls signals applied to the plurality of pixels,
wherein an output signal from the detector output terminal is applied to the signal controller, and the signal controller supplies an input signal to the blocking unit input terminal.

13. The organic light emitting device of claim 7, further comprising:
a data driver attached on the display panel which transmits data voltages to the plurality of pixels; and
a printed circuit board attached to the data driver.

14. The organic light emitting device of claim 13, further comprising a flexible printed circuit film attached on the display panel which transmits the driving voltage to the pixels.

15. The organic light emitting device of claim 13, wherein the overcurrent blocking unit and the driving voltage blocking unit are disposed on the printed circuit board.

16. A method of driving an organic light emitting device, the method comprising:
generating a driving voltage to drive a plurality of pixels in a display panel;
providing the driving voltage to an overcurrent detector;
detecting the presence of an overcurrent in the overcurrent detector;
generating an output signal from the overcurrent detector which corresponds to the detection of an overcurrent; and
blocking the driving voltage to the plurality of pixels of the display panel based on the output signal from the overcurrent detector using a driving voltage blocking unit.
